(19) United States
(12) Patent Application Publication
(10) Pub. No.: US 2008/0150438 A1
(43) Pub. Date: Jun. 26, 2008

(54) PLASMA DISPLAY AND DRIVING METHOD THEREOF

(76) Inventors: Yoo-Jin Song, Yongin-si (KR); Kyong-Pil Jin, Yongin-si (KR)

Correspondence Address: CHRISTIE, PARKER & HALE, LLP, PO BOX 7068, PASADENA, CA, 91109-7068, US

(21) Appl. No.: 11/938,889

(22) Filed: Nov. 13, 2007

(30) Foreign Application Priority Data
Dec. 20, 2006 (KR) 10-2006-0130974

(51) Int. Cl. G09G 3/10

(52) U.S. Cl. 315/169.4

(57) ABSTRACT

A plasma display device and a driving method thereof. The plasma display device includes a first electrode, a power recovery capacitor charged with a first voltage, and a plurality of switches electrically connected between the first electrode and the power recovery capacitor. If the sensing voltage sensed by sensing the voltage of the power recovery capacitor is higher than a reference voltage, the driving voltage used to drive the plurality of switches is prevented (or stopped) from being applied to the plurality of switches, thereby preventing (or protecting) the element constituting the plasma display device from burning out.

### CROSS-REFERENCE TO RELATED APPLICATION

This application claims priority to and the benefit of Korean Patent Application No. 10-2006-0130974, filed in the Korean Intellectual Property Office on Dec. 20, 2006, the entire content of which is incorporated herein by reference.

### BACKGROUND OF THE INVENTION

1. Field of the Invention

Embodiments of the present invention relate to a plasma display device and a driving method thereof.

2. Description of the Related Art

A plasma display device (referred to also as a plasma display) is a display device that uses a plasma display panel (PDP) for displaying characters or images by using plasma generated by a gas discharge. The PDP includes a plurality of discharge cells arranged in a matrix pattern.

In a plasma display, one frame (or one TV field) is divided into a plurality of respectively weighted subfields, and the subfields are driven. Each subfield has a reset period, an address period, and a sustain period with respect to time.

The reset period is a period during which the state of each cell is initialized such that an addressing operation of each cell can be smoothly performed. The address period is a period during which an address voltage is applied to an addressed cell to accumulate wall charges in the addressed cell in order to select a cell to be turned on or turned off in the panel. The sustain period is a period during which a sustain discharge pulse is applied to the addressed cell to actually cause the display of images.

Such a plasma display device uses a scan integrated circuit (IC) in order to sequentially apply a scan pulse to a plurality of scan electrodes. Generally, a control signal for controlling an operation is inputted in the scan integrated circuit. Here, if an abnormal control signal is inputted, a driving circuit device may burn out.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of an embodiment of the present invention has been made in an effort to provide a plasma display device, which can prevent (or protect) a driving circuit device from burning out in the plasma display device, and a driving method thereof.

According to one embodiment of the present invention, a plasma display device is provided. The plasma display device includes a driving circuit having a portion for applying a plurality of voltages to a first electrode. The plasma display device further includes: a power recovery capacitor adapted to be charged with a first voltage; a first switch electrically connected between the power recovery capacitor and the portion of the driving circuit for applying the plurality of voltages, the first switch being for controlling an application of the plurality of voltages; a first power source for supplying a driving voltage for driving the first switch to the first switch; a second switch electrically connected between the first switch and the first power source; and an error sensor for sensing the first voltage and for controlling the second switch by comparing the first voltage with a reference voltage.

According to another embodiment of the present invention, a plasma display device includes: a first electrode for receiving a plurality of voltages; a driver including a power recovery capacitor adapted to recover a power applied to the first electrode and a plurality of switches for controlling one or more applications of the plurality of voltages to the first electrode; a power source unit including a first power source for supplying a driving voltage for driving the plurality of switches to the plurality of switches; a first switch electrically connected between the first power source and the plurality of switches and adapted to control whether to supply the driving voltage to the plurality of switches; and an error sensor for sensing a voltage of the power recovery capacitor and for controlling the first switch by comparing the first voltage with a reference voltage.

According to yet another embodiment of the present invention, there is provided a driving method of a plasma display device including: a first electrode for receiving a plurality of voltages; a power recovery capacitor charged with a first voltage; and a plurality of switches electrically connected between the first electrode and the power recovery capacitor and for controlling one or more applications of the plurality of voltages to the first electrode. The method includes: sensing a voltage of the power recovery capacitor; comparing the sensed voltage with a reference voltage; and if the sensed voltage is less than the reference voltage, applying a driving voltage used to drive the plurality of switches to the plurality of switches, and if the sensed voltage is greater than the reference voltage, stop applying the driving voltage to the plurality of switches.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a view showing a plasma display device according to an exemplary embodiment of the present invention.

FIG. 2 is a block diagram schematically showing an internal configuration of a power source unit according to an exemplary embodiment of the present invention.

FIG. 3 is a view schematically showing a scan electrode driver according to an exemplary embodiment of the present invention.

FIG. 4 is a circuit diagram showing the scan electrode driver as shown in FIG. 3 in more detail.

FIG. 5 is a view showing a driving waveform of a plasma display device according to an exemplary embodiment of the present invention.

FIG. 6 is a view showing a current path when a control signal of an integrated circuit (IC) is abnormally applied.

FIG. 7 is a view showing a plasma display device including an error sensor according to an exemplary embodiment of the present invention.

FIG. 8 is a view showing an internal configuration of the error sensor as shown in FIG. 7 according to an exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element can be directly connected to the another element or be coupled to the another element with one or more other elements between them. In addition, unless explicitly described to the contrary, the word “comprise” and variations such as “comprises” or “comprising”, will be understood to imply the inclusion of stated elements but not the exclusion of any other elements.

Wall charges refer to charges that accumulate near the electrodes and are formed in close proximity to the respective electrodes on the wall (e.g., dielectric layer) of the discharge cells. The wall charges do not actually touch the electrodes themselves, even though they may be described as being “formed on,” “stored on,” and/or “accumulated to” the electrodes. Further, a wall voltage represents a potential difference formed on a wall of the discharge cells by the wall charges.

A plasma display device and a driving method thereof according to an exemplary embodiment of the present invention will be described in more detail below.

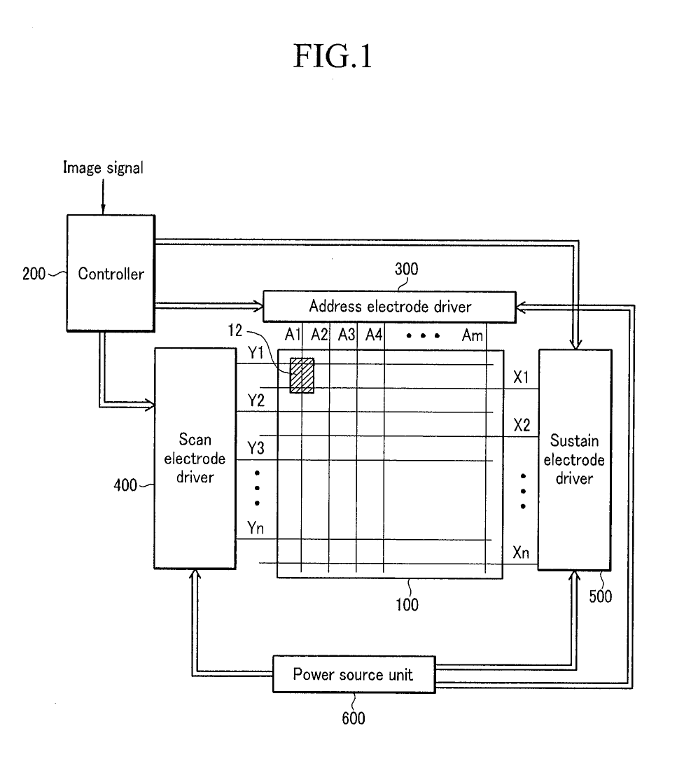

As shown in FIG. 1, a plasma display device according to an exemplary embodiment of the present invention includes a plasma display panel 100, a controller 200, an address electrode driver 300, a scan electrode driver 400, and a sustain electrode driver 500.

The plasma display panel 100 includes a plurality of address electrodes (hereinafter also referred to as “A electrodes”) A1 to Am extending in a column direction; and a plurality of sustain electrodes (hereinafter also referred to as “X electrodes”) X1 to Xn and a plurality of scan electrodes (hereinafter also referred to as “Y electrodes”) Y1 to Yn, which are paired, extending in a row direction. The X electrodes X1 to Xn are formed to correspond to the Y electrodes Y1 to Yn, and the X electrodes X1 to Xn and the Y electrodes Y1 to Yn perform a display operation for displaying an image in a sustain period. The Y electrodes Y1 to Yn may cross the address electrodes A1 to Am, and the X electrodes X1 to Xn may cross the address electrodes A1 to Am. In this instance, discharge spaces are provided at where the address electrodes A1 to Am cross the X and Y electrodes X1 to Xn and Y1 to Yn form discharge cells 110. The plasma display panel 100 is only one example of a plasma display panel, and the present invention is not thereby limited.

In FIG. 1, the controller 200 receives an external image signal, and outputs an address electrode drive control signal, a sustain electrode drive control signal, and a scan electrode drive control signal. The controller 200 divides one frame into a plurality of subfields for driving. Each subfield has a reset period, an address period, and a sustain period with respect to time.

The address driver 300 receives the address electrode drive control signal from the controller 200, and applies a display data signal for selecting one or more desired discharge cells to the respective address electrodes.

The scan electrode driver 400 receives the scan electrode drive control signal from the controller 200 and applies a driving voltage to the X electrodes.

The sustain electrode driver 500 receives the sustain electrode drive control signal from the controller 200 and applies a driving voltage to the Y electrodes.

The power source unit 600 supplies a voltage and/or a current (e.g., a voltage and/or a current of a predetermined magnitude) to the respective drivers 300, 400, and 500 and the controller 200.

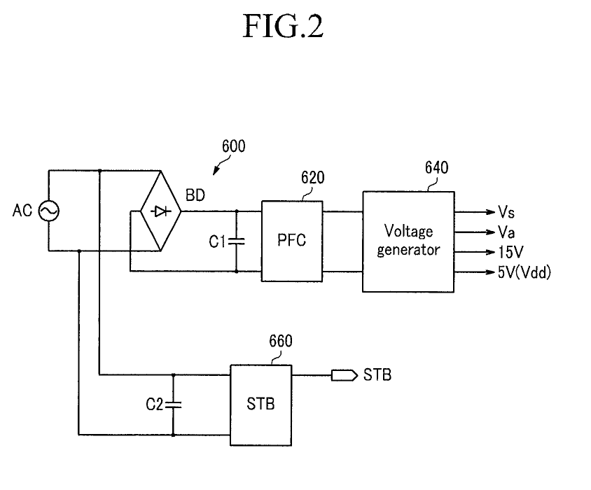

FIG. 2 is a block diagram schematically showing an internal configuration of a power source unit 600 according to an exemplary embodiment of the present invention.

As shown in FIG. 2, the power source unit 600 according to an exemplary embodiment of the present invention includes a bridge diode BD, capacitors C1 and C2, a power factor correction unit (PFC) 620, a voltage generator 640, and a standby unit (STB) 660.

An input AC power is applied and rectified through the bridge diode BD, and this power is charged in the capacitor C1 and inputted into the power factor correction unit 620. The power factor correction unit 620 corrects a power factor of an input voltage and outputs a DC voltage (e.g., a predetermined DC voltage) to the voltage generator 640. The voltage generator 640 includes a plurality of DC-DC converters, receives a voltage outputted from the power factor correction unit 620, generates a plurality of DC voltages Vs, Va, 15V, and 5V (Vdd voltage) used in the plasma display device, and supplies them to the respective drivers 300, 400, and 500. The standby unit 660 receives a voltage charged in the capacitor C2 and generates standby voltages 5V and 9V for output. Here, the voltage of 5V generated from the voltage generator 640 is used as a voltage Vdd (hereinafter also referred to as a “driving voltage Vdd”) used to drive a plurality of transistors constituting the scan electrode driver 400. That is, the plurality of transistors is driven only when the driving voltage Vdd is inputted from the voltage generator 640.

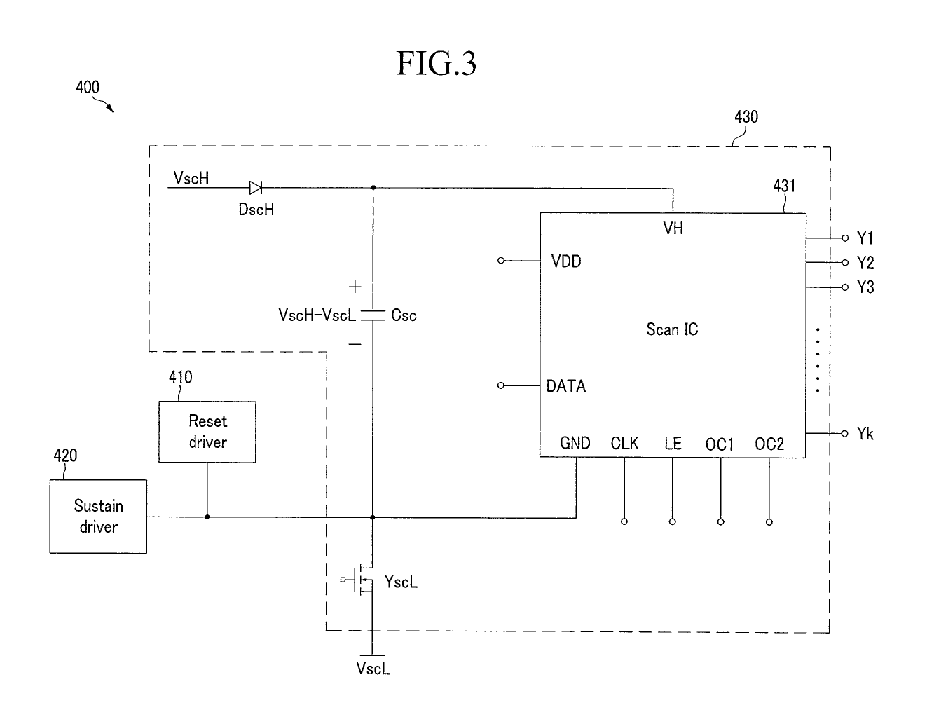

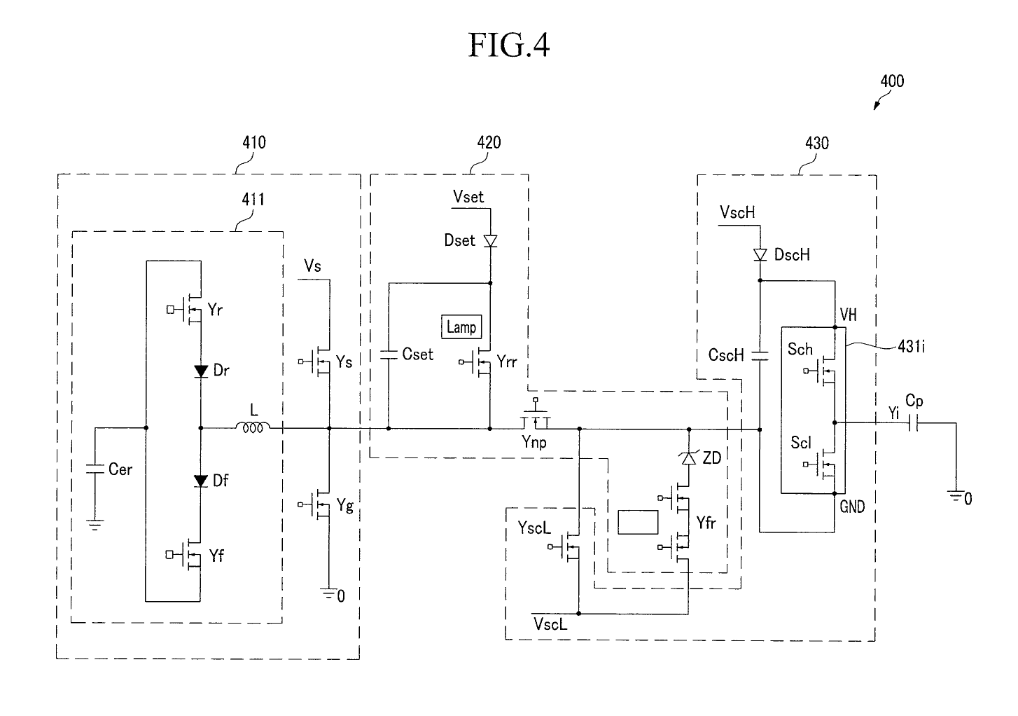

FIG. 3 is a view schematically showing a scan electrode driver 400 according to an exemplary embodiment of the present invention. FIG. 4 is a circuit diagram showing the scan electrode driver 400 as shown in FIG. 3 in more detail.

As shown in FIG. 3, the scan electrode driver 400 includes a reset driver 410, a sustain driver 420, and a scan driver 430. The scan driver 430 includes a scan integrated circuit (hereinafter also referred to as a “scan IC”) 431, a capacitor CscH, a diode DscH, and a transistor YscL.

The scan IC 431 has a plurality of output terminals connected to a plurality of Y electrodes Y1-Yk, and is driven by control signals OC1 and OC2, a clock CLK, data DATA, a latch signal LE, a power source VDD (e.g., a voltage of the power source VDD), etc. In one embodiment, the number of output terminals of the scan IC 431 is the same as the number of Y electrodes Y1 to Yn (e.g., k is equal to n). More specifically, the scan IC 431 includes a plurality of scan circuits 431i as shown in FIG. 4, and the number thereof is the same as the number of Y electrodes Y1 to Yn. FIG. 4 illustrates only one scan circuit 431i connected to one Y electrode Yi for convenience purposes. The scan circuit 431i has a high voltage terminal VH and a low voltage terminal GND, an output terminal C is connected to the Y electrode Yi, and a scan high voltage of the high voltage terminal VH and a scan low voltage of the low voltage terminal GND are selectively applied to the corresponding Y electrode Yi in order to select lighting cells in the address period. In another embodiment, if the number of output terminals of the scan IC 431 is less than the number of Y electrodes Yi to Yn (e.g., k is less than n), one or more scan ICs 431 including a plurality of scan circuits (e.g., the scan circuits 431i) can be used. Such a scan IC 431 may include SN755864, STV7617, and the like.

As shown in FIG. 4, the scan circuit 431i includes transistors Sch and Scl. The source of the transistor Sch and the drain of the transistor Scl are coupled to the Y electrode Yi of a panel capacitor Cp (here, e.g., the panel capacitor Cp is for representing a capacitive load of the plasma display panel 100).

An anode of a diode DscH is connected to a power source for supplying a voltage VscH, and a cathode of the diode DscH is connected to the high voltage terminal VH of the scan circuit 431i. A first terminal of a capacitor CscH is connected to the cathode of the diode DscH, and a second terminal of the capacitor CscH is connected to the low voltage terminal GND of the scan circuit 431i. A transistor YscL is connected between a power source for supplying a voltage VscL and the low voltage terminal GND of the scan circuit 431i. Here, if the transistor YscL is turned on, the capacitor CscH is charged with a voltage VscH-VscL.

As shown in FIG. 3, the control signals OC1 and OC2 are signals for controlling the operation of the scan IC 431, and the operation of the scan IC 431 is determined by the level of the control signals OC1 and OC2. However, even if the control signals OC1 and OC2 are inputted into the scan IC 431, the operation of the scan IC 431 is stopped unless the driving voltage Vdd is inputted into the scan IC 431. More specifically, if the driving voltage Vdd (e.g., the driving voltage Vdd of the power source VDD) used to drive the plurality of transistors Sch and Scl constituting the scan circuit 431i of the scan IC 431 is not inputted, the operation of the plurality of transistors Sch and Scl is stopped. In addition, if the driving voltage Vdd is not inputted, any voltage is outputted to output terminal(s) HVO of the scan IC 431. Here, the output terminal(s) HVO include(s) all (or substantially all) of the output terminals of the scan IC 431 connected to the Y electrode Y1-Yk.

Table 1 is a table representing the SN755864 IC In Table 1, “H” is a high level, “L” is a low level, and X represents both high level and low level.

TABLE 1

| DATA | OC1 | OC2 | HVO |
|---|---|---|---|
| X | H | L | output voltage of the low voltage terminal GND |
| | | | to all output terminals HVO |
| X | L | L | set all output terminals HVO to high impedance |
| | | | state |
| X | H | H | output voltage of the high voltage terminal |
| | | | VH to all output terminals HVO |
| H | L | H | apply the scan low voltage sequentially to |
| | | | the output terminals HVO |
| L | L | H | apply the scan high voltage to the terminal VH |

As in Table 1, if the control signal OC1 is at a high level H and the control signal OC2 is at a low level L, the scan IC 431 outputs a voltage of the low voltage terminal GND to all the output terminals HVO. If the control signals OC1 and OC2 are all at a low level L, the scan IC 431 sets all the output terminals HVO to a high impedance state. If the control signals OC1 and OC2 are all at a high level H, the scan IC 431 outputs a low voltage of the high voltage terminal VH to all the output terminals VHO. If the control signal OC1 is at a low level L and the control signal OC2 is at a high level H, the scan IC 431 performs the operation of sequentially applying a scan pulse to the plurality of output terminals HVO. Here, if the input data DATA is at a high level, the scan low voltage VscL, which is a voltage of the low voltage terminal GND, is outputted to the output terminal VHO of the scan IC 431, and if the input data DATA is at a low level, a scan high voltage VscH, which is a voltage of the high voltage terminal VH, becomes a voltage of the scan IC 431. The scan IC 431 sequentially applies a turn-on signal to the plurality of transistors ScH and ScL in response to a latch signal LE, thereby sequentially outputting a scan pulse to the Y electrode. Here, an interval at which the turn-on signal is sequentially shifted is determined by a clock CLK. The scan IC 431 may include a shift register, a latch, and the like for sequentially shifting such a turn-on signal, and a logic gate and the like for generating a turn-on signal. Here, the shift register, latch, logic gate and the like may be operated by the driving voltage Vdd. Accordingly, if the driving voltage Vdd is not inputted, the operation of the shift register, latch, logic gate, and the like is stopped. If the operation of the shift register, latch, logic gate, and the like is stopped, any voltage is outputted to the output terminal(s) HVO of the scan IC 431.

The reset driver 410 and sustain driver 420 are connected to the low voltage terminal GND of the scan IC 431 of the scan driver 430. The reset driver 410 applies a reset waveform to the plurality of Y electrodes through the low voltage terminal GND of the scan IC 431 during the reset period of each subfield, and the sustain driver 420 applies a sustain discharge pulse to the plurality of Y electrodes through the low voltage terminal of the scan IC 431 during the sustain period of each subfield.

Referring to FIG. 4, the circuit of the scan electrode driver 400 as shown in FIG. 3 will be described in more detail below. FIG. 4 illustrates one scan circuit 431i connected to one Y electrode Yi. In addition, in FIG. 4, the transistors are illustrated as n-channel electric field effect transistors, e.g., NMOS (n-channel metal oxide semiconductor) transistors. Each of these transistors may have a body diode in the direction from the source to the drain. In addition, one or more of the NMOS transistors may be replaced with another transistor performing the same function. In addition, although FIG. 4 illustrates each of the transistors as being one transistor, each of the illustrated transistors may also be formed as a plurality of transistors connected in parallel and series. Moreover, a capacitive component formed by the X electrode and the Y electrode is illustrated as the panel capacitor Cp (e.g., the panel capacitor Cp represents the capacitive load of the plasma display panel 100).

As shown in FIG. 4, the sustain driver 420 includes a power recovery unit 411 and transistors Ys and Yg. The power recovery unit 411 includes transistors Yr and Yf, an inductor L, diodes Dr and Df, and a power recovery capacitor Cer.

The transistor Ys is connected between a power source for supplying a voltage Vs and the Y electrode (e.g., electrode Yi) of the panel capacitor Cp, and the transistor Yg is connected between a power source 0V for supplying a voltage 0V and the Y electrode of the panel capacitor Cp. Here, the transistor Ys applies the voltage Vs to the Y electrode, and the transistor Yg applies the voltage 0V to the Y electrode.

A first terminal of the capacitor Cer is connected between the contact of the transistors Ys and Yg, and the power recovery capacitor Cer is charged with a voltage Vs/2 which is halfway between the voltage Vs and the voltage 0V. A source of the transistor Yr is connected to a second terminal of the inductor L whose first terminal is connected to the Y electrode, a drain of the transistor Yr is connected to a first terminal of the power recovery capacitor Cer, a drain of the transistor Yf is connected to the second terminal of the inductor L, and a source of the transistor Yf is connected to the first terminal of the power recovery capacitor Cer.

In addition, the diode Dr is connected between the source of the transistor Yr and the inductor L, and the diode Df is connected between the drain of the transistor Yf and the inductor L. The diode Dr is for setting a rising path for increasing a voltage of the Y electrode if the transistor Yf has a body diode transistor, and the diode Df is for setting a falling path for decreasing a voltage of the Y electrode if the transistor Yf has a body diode. At this time, unless the transistors Yr and Yf have a body diode, the diodes Dr and Df may be removed. The thus-connected power recovery unit 411 increases the voltage of the Y electrode from the voltage 0V to the voltage Vs or decreases the same from the voltage Vs to the voltage 0V by using a resonance between the inductor L and the panel capacitor Cp.

In addition, the order of connection among the inductor L, diode Df, and transistor Yf in the power recovery unit 411 may be suitably changed, and the order of connection among the inductor L, diode Dr, and transistor Yr also may be suitably changed. For example, the inductor L may be connected between the contact of the transistors Yr and Yf and the power recovery capacitor Cer. Moreover, although FIG. 3 illustrates that the inductor L is connected to the contact of the transistors Yr and Yf, the inductor may be connected on the rising path formed by the transistor Yr and on the falling path formed by the transistor Yf, respectively.

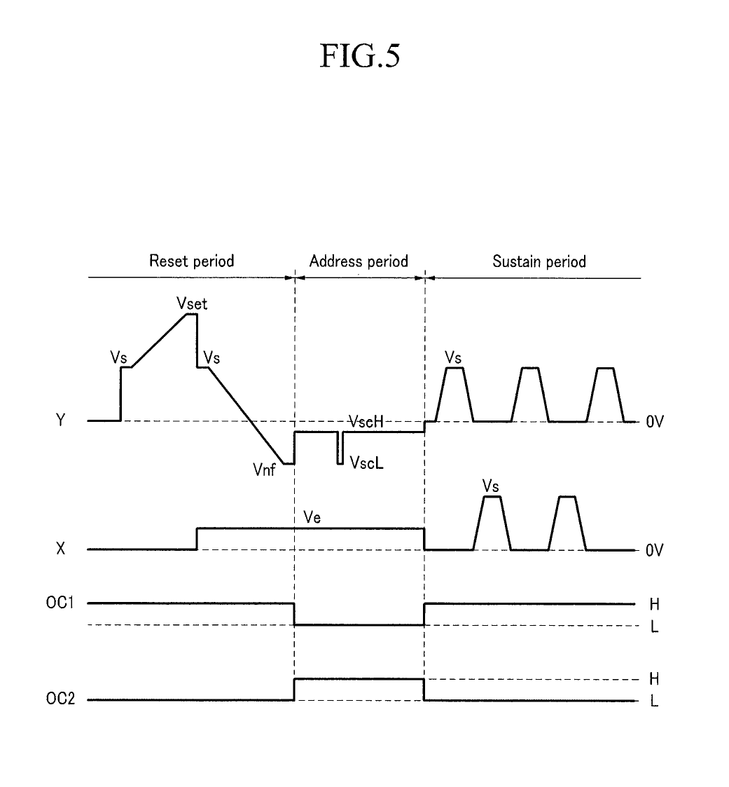

The reset driver 410 includes transistors Yrr, Yfr and Ynp, a capacitor Cset, a Zener diode ZD, and a diode Dset. The reset driver 410 gradually increases the voltage of the Y electrode from the voltage Vs to the voltage Vset in the rising period of the reset period and gradually decreases the voltage of the Y electrode from the voltage Vs to a voltage Vnf in the falling period of the reset period. A source of the transistor Yrr whose drain is connected to a power source for supplying the voltage Vset is connected to the Y electrode of the capacitor Cp through the transistor Ynp. The diode Dset is formed in the opposite direction of the body diode of the transistor Yrr in order to prevent (or block) current caused by the body diode. In addition, the transistor Yfr is connected between the power source for supplying the voltage VscL and the Y electrode of the panel capacitor Cp, and the voltage Vnf can be higher than the voltage VscL in the driving waveform of FIG. 5, thus the cathode of the Zener diode ZD is connected to the transistor Yfr. Here, it is assumed that the voltage Vnf is a voltage which is increased as high as the voltage VscL as compared to the VscL. Since the voltage Vnf can be higher than the voltage VscL, a current path can be formed through the body diode of the transistor Yfr when the transistor YscL is turned on. Accordingly, the transistor Yfr can be formed in a back-to-back pattern in order to prevent (or block) the current path caused by the body diode of the transistor Yfr.

The scan driver 430 includes the scan circuit 431i, the capacitor CscH, the diode DscH, and the transistor YscL. The scan driver 430 applies the voltage VscL to the Y electrode in order to select the discharge cell to be turned on in the address period and the voltage VscH to the Y electrode of the discharge cell not to be turned on.

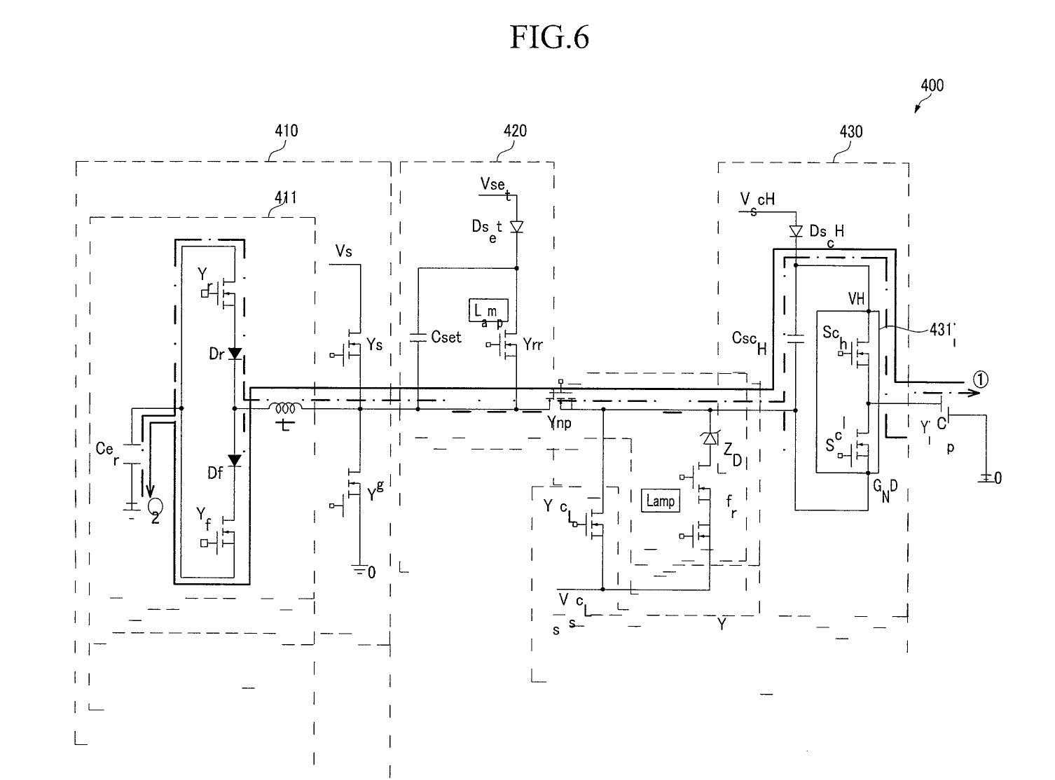

FIG. 5 is a view showing a driving waveform of a plasma display device according to an exemplary embodiment of the present invention. FIG. 6 is a view showing a current path when a control signal of an integrated circuit (IC), e.g., the scan IC 431, is abnormally applied. In FIG. 5, only the driving waveform applied to one X electrode and one Y electrode is illustrated for convenience purposes.

As shown in FIG. 5, one subfield includes a reset period, an address period, and a sustain period.

In the reset period, the sustain electrode driver 500 applies a reference voltage (in FIG. 5, the reference voltage is assumed to be a ground voltage 0V) to the X electrode, and the reset driver 410 of the scan electrode driver 400 turns on the transistor Yrr, thereby gradually increasing the voltage of the Y electrode from the voltage Vs to the voltage Vset. Next, the sustain electrode driver 500 applies the voltage Ve to the X electrode, and the scan electrode driver 400 turns on the transistor Yfr, thereby decreasing the voltage of the Y electrode from the voltage Vs to the voltage Vnf. At this time, the voltage is applied to the Y electrode through the low voltage terminal GND of the scan circuit 431i, thus the control signal OC1 at the high level H and the control signal OC2 at the low level L are applied by the controller 200 to the scan IC 431 during the reset period.

In the address period, the scan driver 430 of the scan electrode driver 400 turns on the transistor YscL, thereby applying the voltage VscL to the low voltage terminal GND of the scan circuit 431i and applying the voltage VscH to the high voltage terminal VH. The controller 200 supplies the scan IC 431 with the input data at the high level H, the control signal OC1 at the low level L, the control signal OC2 at the high level H, and a latch signal LE. Then, the scan circuit 431i may sequentially apply a scan pulse having the voltage VscL to the plurality of Y electrodes, and may apply the voltage VscH higher than the voltage VscL to the Y electrodes to which (and/or during which) the scan pulse is not applied.

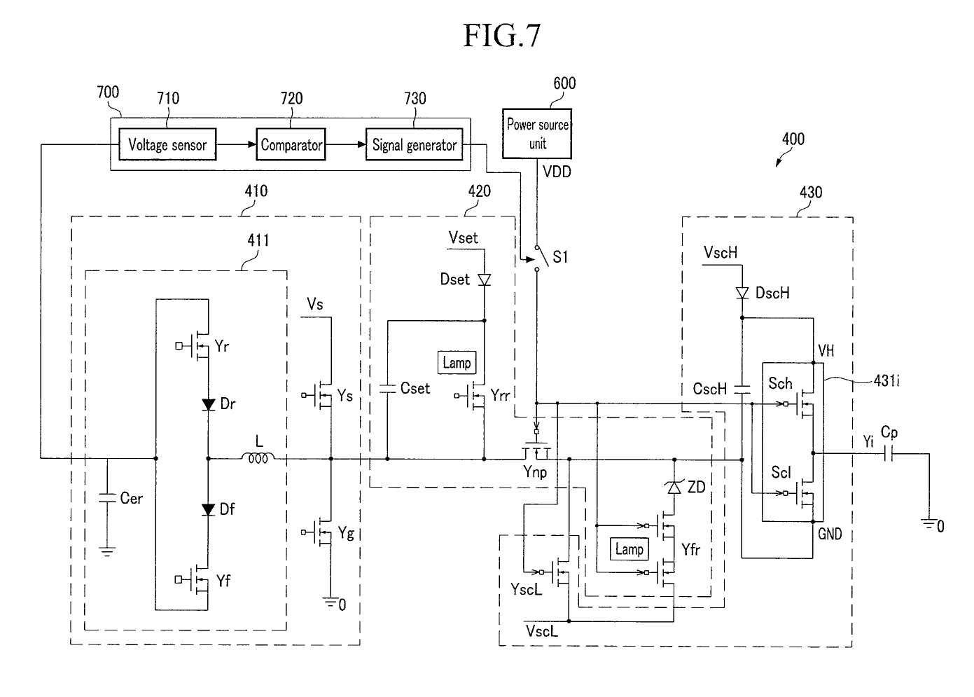

In addition, in the sustain period, the controller 200 applies the control signal OC1 at the high level H and the control signal OC2 at the low level L to the scan IC 431. Also, the sustain driver 420 of the scan electrode driver 400 alternately applies a voltage Vs and a ground voltage 0V through the low voltage terminal GND of the scan circuit 431i. At this time, if an error occurs in the control signals OC1 and OC2 inputted into the scan IC 431 from the controller 200 adapted to apply the control signal OC2 at high level H to the scan IC 431 in the sustain period, the transistor Sch of the scan circuit 431i may be turned on. If the transistor Sch is turned on in the sustain period, current paths \textcircled{1} and \textcircled{2} as shown in FIG. 6 are formed. A sustain discharge pulse is applied to the Y electrode through these current paths \textcircled{1} and \textcircled{2}. In more detail, if the current path \textcircled{1} is formed, the voltage of the Y electrode is increased from 0V to the voltage Vs through the transistor Sch, and a voltage higher than the voltage VscH-VscL is charged in the capacitor CscH. Generally, the transistor Sch has a relatively small current capacity, so the transistor Sch may be burned out by the current path \textcircled{2}. If the transistor Sch burns out, the elements connected to the transistor Sch may also (or consecutively or consequently) burn out. An exemplary embodiment for preventing (or for protecting a driving circuit from) this burn out is explained below in FIG. 7 in more detail.

If the current path \textcircled{2} as shown in FIG. 6 is formed, the voltage of the Y electrode is discharged from the voltage Vs to the voltage 0V, and the energy charged in the capacitor CscH is added to the power recovery capacitor Cer of the power recovery unit 411. Accordingly, if the control signal OC2 at the high level H is inputted as an error into the scan IC 431 in the sustain period, and thus the transistor Sch is turned on, the voltage of the power recovery capacitor Cer is increased to higher than Vs/2.

A method for protecting a circuit device by using a voltage of the power recovery capacitor Cer is described below with reference to FIG. 7.

FIG. 7 is a view showing a plasma display device according to an exemplary embodiment of the present invention.

As shown in FIG. 7, the plasma display device includes a scan electrode driver 400, a power source unit 600, an error sensor 700, and a switch S1. More specifically, among the plurality of output terminals of the voltage generator 640 in the power source unit 600, a first terminal of a switch S1 is connected to the output terminal 5V (Vdd) for outputting the driving voltage Vdd, and a second terminal of the switch S1 is connected to the scan circuit 431i in the scan electrode driver 400 and the plurality of transistors Ynp, YscL and Yfr. That is, the switch S1 determines whether the driving voltage Vdd is applied to the scan electrode driver 400.

The error sensor 700 includes a voltage sensor 710, a comparator 720, and a signal generator 730. The voltage sensor 710 can be a sensing resistor, a hole sensor, a current transformer, or the like and senses a change in the voltage of the power recovery capacitor Cer. The comparator 720 compares the sense voltage sensed in the voltage sensor 710 and a reference voltage (or a set reference voltage). Here, the reference voltage can be set to the maximum voltage charged in the power recovery capacitor Cer when a sustain discharge pulse is applied through the transistor Scl of the scan circuit 431i in the sustain period. Accordingly, the reference voltage is a voltage Vs/2 which can be set by an experiment, and is equal to a half the sustain discharge firing voltage. The signal generator 730 generates a signal for controlling the operation of the switch S1 according to the result of comparison of the comparator 720.

As explained above, it can be seen that if the sense voltage sensed in the voltage sensor 710 is higher than a reference voltage, the transistor Sch is turned on in the sustain period, thereby forming the current paths (D and (D. Accordingly, if the sense voltage is higher than the reference voltage, the comparator 720 outputs the low signal L to the signal generator 730. If the output signal of the comparator 720 is a low signal L, the signal generator 730 outputs a first control signal. When the first control signal is outputted, the switch S1 is turned off so that the driving voltage Vdd is not applied to the scan circuit 431i and the plurality of Ynp, YscL, and Yfr. Then, the operation of the scan circuit 431i and the plurality of transistors Ynp, YscL and Yfr which use the driving voltage Vdd is stopped, and thus it is possible to prevent (or protect) the device from burning out by undesired current paths \textcircled{1} and \textcircled{2}.

By contrast, it can be seen that if the sensed voltage is less than the reference voltage, the transistor Scl of the scan circuit 431i is turned on in the sustain period, and a sustain discharge pulse is normally applied to the Y electrode. Accordingly, if the sense voltage is less than the reference voltage, the comparator 720 outputs a high signal H to the signal generator 730. If an output signal of the comparator 720 is a high signal H, the signal generator 730 outputs a second control signal. If the second control signal is outputted, the switch S1 is turned on, thereby applying the driving voltage Vdd to the scan circuit 431i and the plurality of transistors Ynp, YscL and Yfr. Then, the scan circuit 431i and the plurality of transistors Ynp, YscL and Yfr using the driving voltage Vdd are normally operated, thereby stably applying a sustain discharge pulse to the Y electrode in the sustain period.

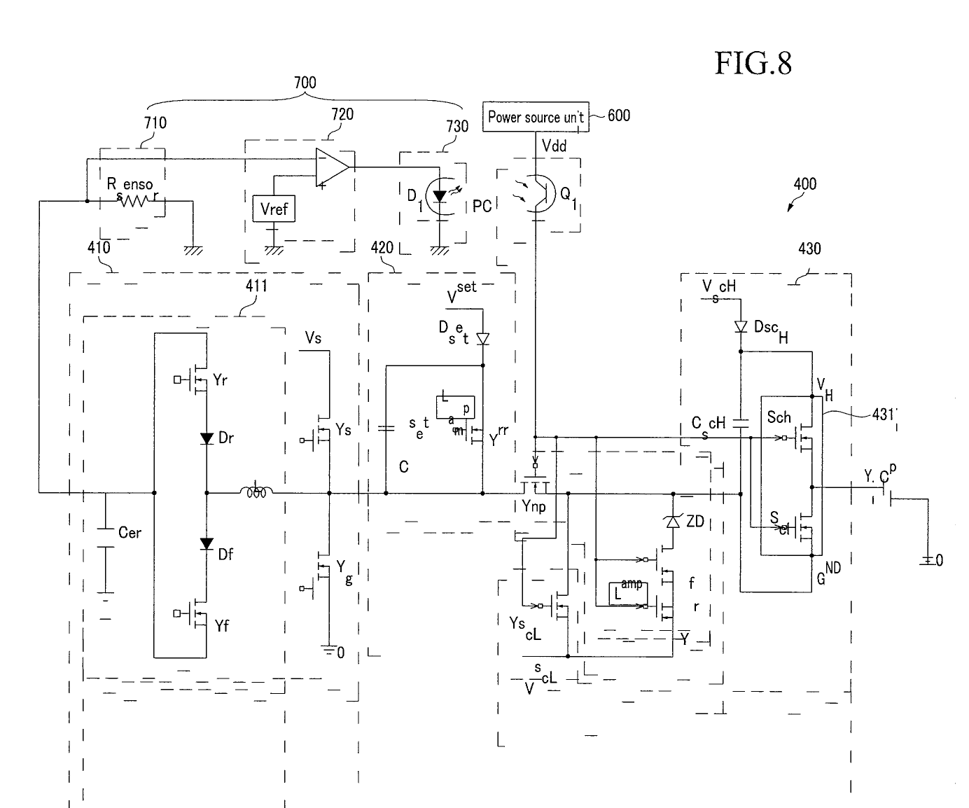

FIG. 8 is a view showing an internal configuration of the error sensor 700 as shown in FIG. 7.

As shown in FIG. 8, the voltage sensor 710 includes a sensing resistor Rsensor connected between the power recovery capacitor Cer and the ground. The comparator 720 includes a comparator OP. The signal generator 730 includes a light emitting diode D1 which is coupled to the second switch if the second switch is a light receiving transistor.

Here, current flows in the sensing resistor Rsensor are proportional to the voltage charged in the power recovery capacitor Cer. Although the sensing resistor Rsensor is used as a unit for sensing a voltage charged in the power recovery capacitor Cer in FIG. 8, the sensing resistor Rsensor can be replaced with a hole sensor, a current transformer, or the like.

A sensing voltage V1 corresponding to the output current flowing in the sensing resistor Rsensor is inputted into the inverse terminal (−) of the comparator OP. A reference voltage Vref is inputted into the non-inverse terminal (+) of the comparator OP. If the sensing voltage V1 inputted into the non-inverse terminal (−) is greater than the reference voltage Vref (that is, the transistor Sch is turned on to apply a sustain discharge pulse, if the current paths \textcircled{1} and \textcircled{2} of FIG. 6 are formed), the comparator OP outputs a low signal L to the signal generator 730. If the low signal L is inputted into the signal generator 730, no voltage is applied to the light emitting diode D1 of the photo coupler PC. Then, no light is generated from the light emitting diode D1 of the photo coupler PC, thereby turning off the light receiving transistor Q1. When the light receiving transistor Q1 is turned off, the driving voltage Vdd is not applied from the power source unit 600 to the scan circuit 431i and the plurality of transistors Ynp, Yscl and Yfr. Then, the operation of the scan circuit 431i and the plurality of transistors Ynp, YscL and Yfr which use the driving voltage Vdd is stopped, and thus it is possible to prevent (or protect) the device from burning out by undesired current paths \textcircled{1} and \textcircled{2}.

By contrast, if the sensing voltage V1 inputted into the inverse terminal (−) is less than the reference voltage Vref (that is, the transistor Scl is turned on to apply a sustain discharge pulse), the comparator OP outputs a high signal H to the signal generator 730. If the high signal H is inputted into the signal generator 730, a voltage is applied to the light emitting diode D1 of the photo coupler PC. Then, light is generated from the light emitting diode D1 of the photo coupler PC, thereby turning on the light receiving transistor Q1. When the light receiving transistor Q1 is turned on, the driving voltage Vdd is applied to the scan circuit 431i and the plurality of transistors Ynp, YscL and Yfr. Then, the scan circuit 431i and the plurality of transistors Ynp, YscL and Yfr using the driving voltage Vdd are normally operated, thereby stably applying a sustain discharge pulse to the Y electrode in the sustain period.

FIG. 8 illustrates one exemplary embodiment for configuring the error sensor 700 as shown in FIG. 7, and the voltage sensor 710, comparator 720, and signal generator 730 are not limited thereto and may be deformed in various suitable forms having the same (or substantially the same) function.

In addition, although FIGS. 7 and 8 illustrate that the driving voltage Vdd from the power source unit 600 is only applied to the transistors Ynp, YscL, Yfr, Sch, and Scl, the driving voltage Vdd can be applied to the other transistors Yr, Yf, Ys, Yg, and Yrr constituting the scan electrode driver 400. Accordingly, if an error is sensed in the error sensor 700, the driving voltage Vdd is not applied to the other transistors Yr, Yf, Ys, Yg, and Yrr, thereby stopping the operation of the other transistors Yr, Yf, Ys, Yg, and Yrr.

In view of the foregoing, an exemplary embodiment of the present invention can prevent (or protect) a device from burning out by sensing a voltage of a power recovery capacitor electrically connected to an electrode, and intercepting a driving voltage applied to a plurality of switches included in a driver if the sensed voltage is higher than a reference voltage.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display device including a driving circuit having a portion for applying a plurality of voltages to a first electrode, the plasma display device comprising:
a power recovery capacitor adapted to be charged with a first voltage;
a first switch electrically connected between the power recovery capacitor and the portion of the driving circuit for applying the plurality of voltages, the first switch being for controlling an application of the plurality of voltages;
a first power source for supplying a driving voltage for driving the first switch to the first switch;
a second switch electrically connected between the first switch and the first power source; and
an error sensor for sensing the first voltage and for controlling the second switch by comparing the first voltage with a reference voltage.

2. The plasma display device of claim 1, wherein the error sensor is adapted to turn off the second switch if the first voltage is higher than the reference voltage, and to turn on the second switch if the first voltage is not higher than the reference voltage.

3. The plasma display device of claim 1, further comprising:
a third switch electrically connected between the first electrode and a second power source for supplying a scan high voltage to the first electrode; and
a fourth switch electrically connected between the first electrode and the first switch,
wherein the second switch is adapted to supply the driving voltage to the third and fourth switches.

4. The plasma display device of claim 3, further comprising:
a fifth switch electrically connected between the first electrode and a third power source for supplying a scan low voltage to the first electrode; and
wherein the second switch is further adapted to supply the driving voltage to the fifth switch.

5. The plasma display device of claim 1, further comprising:
a third switch electrically connected between the first electrode and a second power source for supplying a scan low voltage to the first electrode; and
wherein the second switch is further adapted to supply the driving voltage to the third switch.

6. The plasma display device of claim 1, wherein the error sensor comprises:
a voltage sensor for sensing the first voltage to be charged in the power recovery capacitor;
a comparator for comparing the first voltage sensed by the voltage sensor with the reference voltage; and
a signal generator for outputting a signal for turning on the second switch when a first signal is outputted from the comparator and for outputting a signal for turning off the second switch when a second signal is outputted from the comparator.

7. The plasma display device of claim 6, wherein the voltage sensor comprises a sensing resistor electrically connected to both terminals of the power recovery capacitor to sense the first voltage.

8. The plasma display device of claim 6, wherein the comparator comprises an op-amp configured to receive the first voltage into its inverse terminal and to receive the reference voltage into its non-inverse terminal, and wherein the comparator is adapted to output the first signal if the first voltage is less than the reference voltage and to output the second signal if the first voltage is not less than the reference voltage.

9. The plasma display device of claim 6, wherein the signal generator comprises a light emitting diode optically coupled to the second switch,
wherein the second switch is a light receiving transistor, and
wherein the light emitting diode is adapted to emit light when the first signal is outputted from the comparator and not to emit light when the second signal is outputted from the comparator.

10. The plasma display device of claim 1, wherein the reference voltage is a maximum voltage that can be charged in the power recovery capacitor to stably apply the plurality of voltages to the first electrode.

11. A plasma display device comprising:
a first electrode for receiving a plurality of voltages;
a driver including a power recovery capacitor adapted to recover a power applied to the first electrode and a plurality of switches for controlling one or more applications of the plurality of voltages to the first electrode;
a power source unit including a first power source for supplying a driving voltage for driving the plurality of switches to the plurality of switches;
a first switch electrically connected between the first power source and the plurality of switches and adapted to control whether to supply the driving voltage to the plurality of switches; and
an error sensor for sensing a voltage of the power recovery capacitor and for controlling the first switch by comparing the first voltage with a reference voltage.

12. The plasma display device of claim 11, wherein the error sensor is adapted to turn off the first switch if the first voltage is higher than the reference voltage, and to turn on the first switch if the first voltage is not higher than the reference voltage.

13. The plasma display device of claim 11, wherein the error sensor comprises:
a voltage sensor for sensing the voltage to be charged in the power recovery capacitor;
a comparator for comparing the sensed voltage with the reference voltage; and
a signal generator for outputting a signal for turning on the first switch when a first signal is outputted from the comparator and for outputting a signal for turning off the first switch when a second signal is outputted from the comparator.

14. The plasma display device of claim 13, wherein the voltage sensor comprises a sensing resistor electrically connected to both terminals of the power recovery capacitor to sense the voltage.

15. The plasma display device of claim 13, wherein the comparator comprises an op-amp adapted to receive the sensing voltage into its inverse terminal and to receive the reference voltage into its non-inverse terminal, and wherein the comparator is adapted to output the first signal if the sensing voltage is less than the reference voltage and to output the second signal if the sensing voltage is not less than the reference voltage.

16. The plasma display device of claim 13, wherein the signal generator comprises a light emitting diode optically coupled to the first switch,
wherein the first switch is a light receiving transistor, and
wherein the light emitting diode is adapted to emit light when the first signal is outputted from the comparator and to not emit light when the second signal is outputted from the comparator.

17. The plasma display device of claim 11, wherein the reference voltage is a maximum voltage that can be charged in the power recovery capacitor to stably apply the plurality of voltages to the first electrode.

18. A driving method of a plasma display device including: a first electrode for receiving a plurality of voltages; a power recovery capacitor charged with a first voltage; and a plurality of switches electrically connected between the first electrode and the power recovery capacitor and for controlling one or more applications of the plurality of voltages to the first electrode, the method comprising:
sensing a voltage of the power recovery capacitor;
comparing the sensed voltage with a reference voltage; and
if the sensed voltage is less than the reference voltage, applying a driving voltage used to drive the plurality of switches to the plurality of switches, and if the sensed voltage is greater than the reference voltage, stop applying the driving voltage to the plurality of switches.

19. The method of claim 18, wherein the voltage of the power recovery capacitor is sensed by a sensing resistor electrically connected to both terminals of the power recovery capacitor.

20. The method of claim 18, wherein the reference voltage is a maximum voltage that can be charged in the power recovery capacitor to stably apply the plurality of voltages to the first electrode.
